(19) United States
(12) Patent Application Publication
(10) Pub. No.: US 2008/0025402 A1
(43) Pub. Date: Jan. 31, 2008

(54) Method of detecting scene conversion for controlling video encoding data rate

(75) Inventors: Chang-Hyun Lee, Seoul (KR); Jae-Seok Kim, Seoul (KR); Seong-Joo Lee, Seoul (KR); Yun-Je Oh, Yongin-si (KR); Young-Hun Joo, Yongin-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/880,205

(22) Filed: Jul. 20, 2007

(30) Foreign Application Priority Data
Jul. 27, 2006 (KR) 70858/2006

(51) Int. Cl. H04N 7/12

(52) U.S. Cl. 375/240.16; 375/E07.076

(57) ABSTRACT

A method of detecting scene conversion in real time for controlling a video encoding data rate, includes: estimating PSNR (Peak Signal to Noise Ratio) of a current frame by using error information between the current frame and the previous frame(a reference frame); determining whether the estimated PSNR escapes a predetermined reference value; and considering that the scene conversion is performed in the current frame when the estimated PSNR escapes the predetermined reference value.

### CLAIM OF PRIORITY

This application claims priority to an application entitled “Method Of Detecting Scene Conversion for Controlling Video Encoding Data Rate,” filed in the Korean Intellectual Property Office on Jul. 27, 2006 and assigned Ser. No. 2006-70858, the contents of which are hereby incorporated by reference.

### BACKGROUND OF THE INVENTION

1. Field of the Invention

The present invention relates to video encoding, and more particularly to a method of detecting conversion of scenes in real time for controlling the data rate of the video encoding.

2. Description of the Related Art

Various digital video compressing technology has been proposed for obtaining high image quality when a video signal is transmitted or stored at low data rate. Known video compressing technology according to an international standardization are H.261, H.263, H264, MPEG-2, MPEG-4, etc. These compressing technology provides a high compressing rate using a discrete cosine transform (DCT) or a motion compensation (MC), etc. The video compressing technology is designed to efficiently transfer any digital network streams of the video data, for example, a mobile terminal network, a computer network, a cable network, a satellite network, etc. Moreover, the video compressing technology is applied to efficiently transfer information to a memory media, such as a hard disk, an optical disk, and a digital video disk (DVD), etc.

For high quality of images, a large amount of data is required in the video encoding. However, a communication network by which the video data is transferred may limit the data rate applied to the encoding. For example, a data channel of a satellite broadcasting system or a data channel of a digital cable television network normally transfers the data with a constant bit rate. Also, the storing capacity of the storing media such as the disk is defined.

Therefore, a video encoding process properly trades off the number of bits required to the image quality and the image compression. Also, the video encoding requires complex processes relatively and lots of CPU cycles comparatively in operating using a software. Furthermore, when the video encoding is processed and reproduced in real time, the time condition limits accuracy in operating encoding. As a result, the quality is restricted.

As described above, the data rate control of the video encoding is an important aspect in real using environment, and the data rate control of the video encoding is provided to obtain high image quality.

In JVT(Joint Video Team: ITU-T Video Coding Experts Group and ISO/IEC 14496-10 AVC Moving Picture Experts Group, Z. G. Li, F. Pan, K. P. Lim, G Feng, X. Lin, and S. Rahardja, “Adaptive basic unit layer rate control for JVT”, JVT-G012-rl, 7^{th} Meeting Pattaya, II, Thiland, March 2003), a basic technology of controlling the data rate is disclosed by controlling the Quantization Parameter(QP) in encoding the video frame according to an MPEG video compressing algorithm.

The flow of controlling the encoding data rate is broken if a conversion of scenes at an inter frame in a group of picture (GOP) when the video encodes at the condition where restricted a given resource (for example, transmission rate, etc.) is restricted. The reason is that the encoding data rate control is made under the condition where the frame is similar to previous the frame. The method of detecting scene conversion in real time is required to prevent the above mentioned case.

To detect scene conversion, methods such as a correlation, a statistical sequential analysis, and a Histogram, etc. are used for finding similarities between adjacent frames. Also, in the video compressed by H.264/AVC, it is possible that an intra coded macro-block exists within inter frames in a process of rate distortion optimization (RDO), and the frame is considered to convert the scenes when the number of the intra coded macro-block within the inter frames is over the predetermined level.

The method of determining whether to convert scenes by the number of the intra coded macro-block within the inter frames in the video compressed by H.264/AVC is simple, but it is not possible to process the detection in real time. In other words, it does not know the number of the intra coded macro-block within the inter frames without Quantization Parameter by “Chicken & Egg dilemma” generated in the H.264/AVC RDO process.

Other methods for detecting scene conversion in real time require a complex additional function. In the case of a Color-Histogram algorithm, which is mainly used for enhancing images, additional functions are required, such as the image data being converted to a corresponding a color space, then the image data is re-calculated, etc. The hardware complexity of the video codec requiring a millions of gate counts is increased. For example, an inventor, Moon Chul Kim in a patent application number, 10-2002-39579 discloses this (Title: Apparatus of detecting scene conversion and method of the same, Application date: Jul. 9, 2002).

### SUMMARY OF THE INVENTION

Accordingly, the present invention has been made to solve the above-mentioned problems occurring in the prior art and provides additional advantages, by providing a method of detecting scene conversion in real time for controlling date rate of video encoding in order to detect a scene conversion in real time with less hardware complexity and more efficiency.

In accordance with an aspect of the present invention, a method of detecting scene conversion in real time for controlling a video encoding data rate includes: estimating PSNR(Peak Signal to Noise Ratio) of a current frame by using error information between the current frame and the previous frame(a reference frame); determining whether the estimated PSNR escapes a predetermined reference value; and considering that the scene conversion is performed in the current frame when the estimated PSNR escapes the predetermined reference value.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram of a video encoder device according to the present invention.

FIG. 2 is a flow of operation for detecting scenes in real time according to one embodiment of the present invention.

FIG. 3 is a graph showing the test results of the operation for detecting scenes in real time according to one embodiment of the present invention.

### DETAILED DESCRIPTION OF THE INVENTION

Hereinafter, exemplary embodiments of the present invention will be described with reference to the accompanying drawings. In the following description, the same elements will be designated by the same reference numerals although they are shown in different drawings. Further, various specific definitions found in the following description are provided only to help general understanding of the present invention, and it is apparent to those skilled in the art that the present invention can be implemented without such definitions.

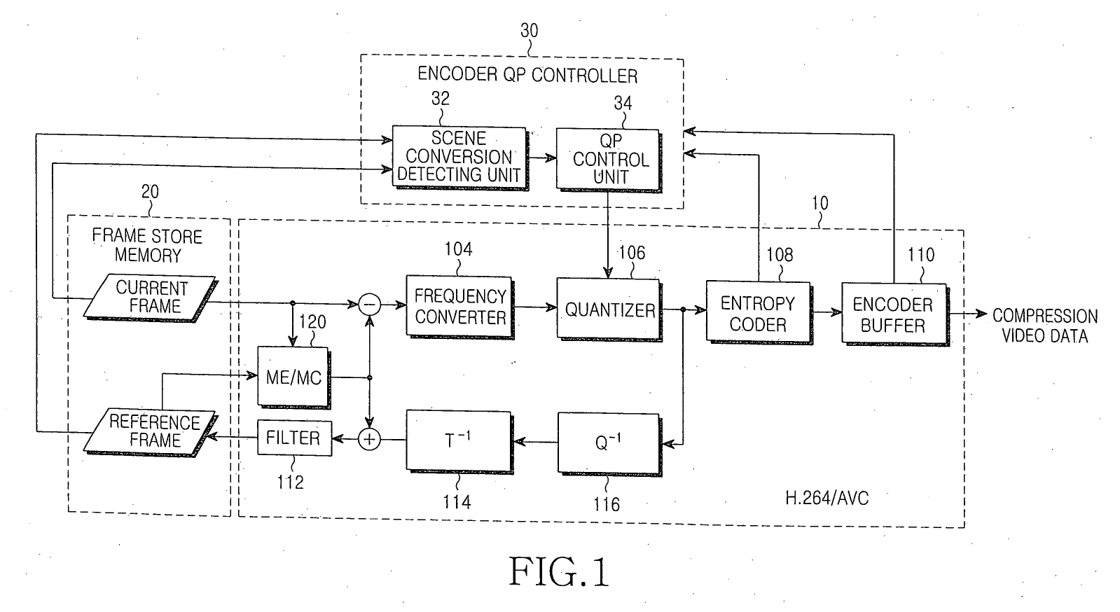

FIG. 1 is a block diagram of a video encoder device according to the present invention. As shown, the inventive video encoder apparatus includes a general H.264/AVC (Advanced Video Coding) encoder 10 for compressing video data inputted thereto, a frame store memory 20 for storing the frames, and an encoder QP controller 30 for controlling the QP (Quantization Parameter) in order to control data rate of the encoder 10.

The encoder 10 further includes a frequency converter 104, a quantizer 106, an entropy coder 108, an encoder buffer 110, de-quantize 116, an inverse frequency converter 114, a motion estimation/compensation unit 120, and a filter 112.

When a current frame is an inter frame, for example, a P frame, the motion estimation/compensation unit 120 estimates and compensates the motion of the macro-block within the current frame based on a reference frame which reconstructs previous frame buffering in the frame store memory 20. The frame is processed by a unit of the macro-block corresponding to an original image, for example, 16×16 pixels. Each macro-block is encoded to intra or inter. In estimating the motion, the motion information such as a motion vector is outputted as additional information, and in compensating the motion, the current frame in which the motion is compensated is created by applying the motion information to the previous frame which reconstructs the motion information. The frequency converter 104 is provided with differences between the macro-block (an estimation macro-block) of current frames and the original macro-block of the current frames.

The frequency converter 104 converts video information of a space domain into data of a frequency domain (for example, a spectrum). In this case, the frequency converter 104 performs a Discrete Cosine Transform (DCT) function to create a DCT coefficient block by a macro-block unit.

The quantizer 106 quantizes blocks of spectrum data coefficient outputted from the frequency converter 104. The quantizer 106 applies an uniform scholar quantization to the spectrum data with step-size varied based on the each frame normally. The quantizer 106 is provided with various information of the Quantization Parameter (QP) by QP control unit 34 of the encoder QP controller 30 according to each frame in order to control the data rate.

The entropy coder 108 compresses specific additional information of each macro-block (for example, motion information, a space extrapolation mode, a quantization parameter) and output of the quantizer 106. The entropy coding technology applied generally is arithmetic coding, Huffman coding, Run-length coding, and Lempel Ziv (LZ), etc. The entropy coder 108 applies other coding technology to different kinds of information normally.

The entropy coder 108 buffers the compressed video information to the encoder buffer 110. A buffer level indicator of the encoder buffer 110 is provided to the encoder QP controller 30 for controlling data rate. The video information stored in the encoder buffer 110 outputs and deletes by the encoder buffer 110 for example, fixed transmission rate.

On other hands, the de-quantizer 116 performs de-quantization on the quantized spectrum coefficient when the reconstructed current frame is required for following motion estimation/compensation. The inverse frequency converter 114 performs the operation of the frequency converter 104 in reverse, so that a reverse-difference macro-block is created from the de-quantizer 116, for example, reverse DCT conversion. The reverse-difference macro-block is not same as the original difference macro-block due to effects such as signal loss, etc.

When the current frame is the inter frame, reconstructed reverse-difference macro-block creates reconstructed macro-block added to the estimated macro-block of the motion estimation/compensation 120. The reconstructed macro-blocks are stored as the reference frame in the frame store memory 20 to estimate the following frame. At this time, the reconstructed macro-block is a distortion version of the original macro-block so that in some embodiments, discontinuity between the macro-blocks goes on smoothly by applying a de-blocking filter 112 to the reconstructed frame.

The encoder QP controller 30 for controlling QP of the encoder 10 includes scene conversion detecting unit 32, which detects the scene conversion in real time through the current frame and the reference frame, etc., stored in the frame store memory 20. When the scene conversion detecting unit 32 detects the scene conversion, the QP control unit 34 receiving the detecting information controls adequate quantization parameters of the quantizer 106 so as to deal with a scene conversion of the current frame adequately.

The scene conversion detecting unit 32 of the present invention estimates current PSNR (Peak Signal to Noise Ratio) through previous stored reference frame and the current frame inputted so as to discriminate whether to convert scenes. Namely, when the estimated PSNR escapes or exceeds from a predetermined reference value, it is considered that the scene conversion is generated in the current frame. In the present invention, the discrimination as to whether or not the PSNT escapes from the reference value is not to simply compare with the specific critical value, but to confirm a ratio between a PSNR of previous frame(s) calculated in real and the PSNR estimated. The critical value of the scene conversion reduces sensibility which may generate between the images when the described above is performed. It is calculated in equation (1) below.

$${RatioPSNR}_{ i} = \frac{{PPSNR}_{ i}}{( \frac{1}{i - 1} ) {\sum }_{j = 1}^{i - 1} {CPSNR}_{j}} \qquad ( 1 )$$

In equation (1), the RatioPSNR is ratio between a PSNR of previous frame(s) calculated in real and the PSNR estimated. Also, PPSNR means the PSNR estimated in the current frame, and CPSNR is the PSNR calculated in the previous frames. i is a frame number of the current frame, and j is a frame number of the immediately previous frame.

As equation (1), the RationPSNR is the ratio between average of PSNR (CSPNR) by calculating the previous frames and the PSNR (PPSNR) estimated in the current frame. The PPSNR and the CPSNR are calculated by the equations (2) and (3) below, respectively.

$$\begin{matrix}{PPSNR}_{ i} = 10 {log}_{10} \frac{{( {2}^{n} - 1 )}^{2}}{{PMSE}_{ i}} & ( 2 ) \\ {CPSNR}_{j} = 10 {log}_{10} \frac{{( {2}_{n} - 1 )}^{2}}{{CMSE}_{j}} & ( 3 )\end{matrix}$$

In equation (2), PMSE is a Mean Square Error (MSE) estimated in the current frame, and in equation (3), CMSE is a MSE calculated in the previous frame. Here, n indicates the number of the bit having each sample (i.e. each pixel) in equations (2) and (3). Generally, n is 8.

As shown in equations (2) and (3), the PPSNR and the CPSNR are calculated to be identical or similar to error information used in the motion estimation of the current frame and the previous frame or in a mode decision, etc. In equations (2) and (3), the real calculation of the PMSE and the CMSE may be performed according to equations (4) and (5) below, as follows.

$$\begin{matrix}{PMSE}_{ i} = \frac{1}{MN} {\sum }_{m = 0}^{M - 1} {\sum }_{n = 0}^{N - 1} {( {O}_{mn}^{ i} - {R}_{n m}^{i - 1} )}^{2} & ( 4 ) \\ {CMSE}_{j} = \frac{1}{MN} {\sum }_{m = 0}^{M - 1} {\sum }_{n = 0}^{N - 1} {( {O}_{mn}^{j} - {R}_{n m}^{j} )}^{2} & ( 5 )\end{matrix}$$

In equations (4) and (5), Oimn indicates an original sample in the m-th column and m-th row of the i-th frame (i.e. the current frame), and Rjmn indicates an reconstructed reference sample in the m-th column and n-th row of the j-th frame (i.e. the previous frame). A frame includes M[m]×N[n] pixels.

As shown in equation (5), CMSEj is calculated by original samples of the previous j-th frame, and an average square error of samples of j-th reconstructed reference frame, which corresponds to the same m-th column and n-th row. As shown in equation (4), PMSEi is calculated by original samples of the previous i-th frame, and an average square error of samples of (i-1)-th reconstructed reference frame which corresponds to the same m-th column and n-th row.

In the present invention, it is known by the above mentioned equations that the PPSNR is estimated by the error information between samples of the current frame and the previous frame(the reference frame) which was reconstructed. In the present invention, when the value of RatioPSNR is less than 0.5, obtained by the using the equations, it is determined that the scene conversion is performed in the frame. At this point, the critical value 0.5 is a value obtained through a experiment. Variables used in the first to fifth equations are already used in the video codec or the similar variables (for example, SAD: Sum of Absolute Difference) are used so as to rarely increase the complexity of the hardware. Also, the current PSNR value is estimated by using the restructured previous frame (the reference frame) so that a real time operation is possible.

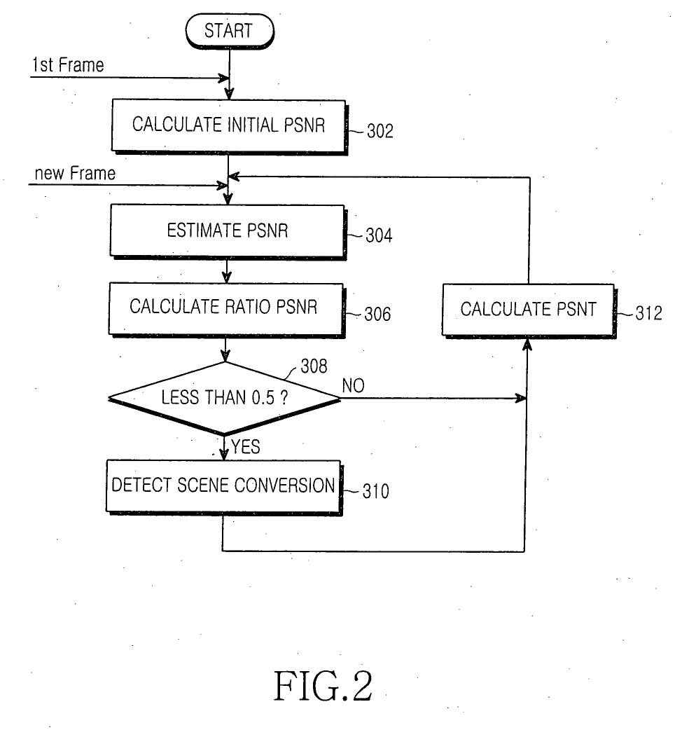

FIG. 2 is a flow chart illustrating the operation steps of detecting scenes in real time according to one embodiment of the present invention. The inventive operation is performed in the scene conversion detecting unit 32 as shown in FIG. 1.

With reference to FIG. 2, when a first frame is inputted, an initial PSNR is calculated in a step 302 as a third equation (3). Then, the PSNR is estimated according to inputting new frames continuously in step 304 as a second equation (2), and the RatioPSNR is calculated in step 306 as a first equation (1).

Thereafter, it is determined whether the RatioPSNR calculated with equation (1) is less than 0.5 in step 308. Here, if the RatioPSNR is not less than 0.5, the PSNR is calculated in step 312, and then the process goes back to the step 304 so as to be repeated. However, if the RatioPSNR is less than 0.5, it is considered that the scene conversion is detected in step 310, and the process goes to step 312 after generating a scene conversion detecting signal, etc. The scene conversion detecting signal may be provided to the QP control unit 34, which adequately controls the quantization parameter of the quantizer 106 in detecting the scene conversion according to the received scene conversion detecting signal.

Note that the above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

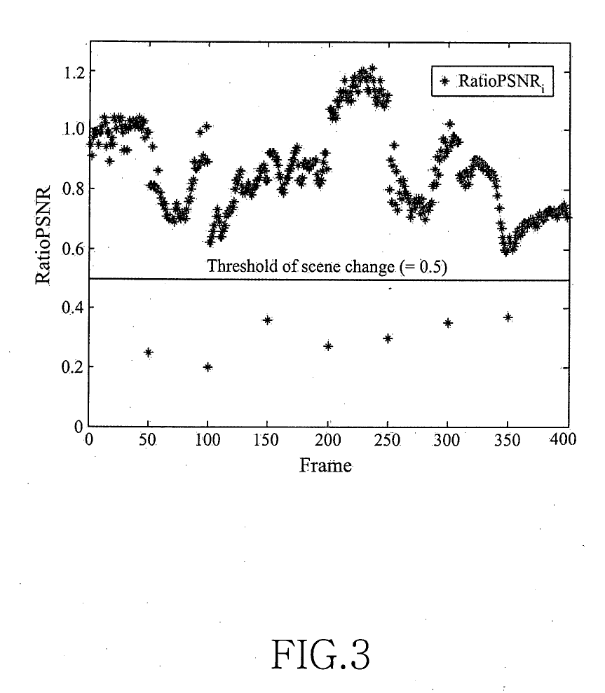

FIG. 3 is a graph showing the test result of the operation of detecting scenes in real time according to one embodiment of the present invention. To test availability of the method of detecting scene conversion according to the present invention, any 8 test sequence images, ‘claire’, ‘news’, ‘foreman’, ‘silent’, ‘miss america’, ‘carphone’, ‘suzie’ and ‘trevor’ are cut by 50 frames, and then are orderly connected to make new images. Thus, the new image generates the scene conversion every fiftieth frame. After that, by using the new image, the RatioPSNR of equation (1) is calculated according to the frames, and the result is shown in the graph of FIG. 3. As shown in FIG. 3, the frame having the RatioPSNR value less than 0.5 is every 50-th frames, as estimated.

For example, while the MSE is used for obtaining the error information in the present invention, the error information is also calculated by SAD, and the scene conversion is detected by using a similar process with the current estimated SAD (PSAD) or the calculated SAD (CSAD). The various changes in form and details may be made therein. Thus, the scope of the invention is not limited by the described embodiments and the scope of the invention as defined by the appended claims. Therefore, the method of detecting scene conversion in real time for controlling the video encoding data rate according to the present invention may reduce complexity of the hardware and detect scene conversion in real time efficiently.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of detecting scene conversion in real time for controlling a video encoding data rate, the method comprising:
estimating a Peak Signal to Noise Ratio (PSNR) of a current frame by using error information between the current frame and a previous frame;
determining whether the estimated PSNR exceeds a predetermined reference value; and
determining that the scene conversion occurred in the current frame when the estimated PSNR exceeds the predetermined reference value.

2. The method as claimed in claim 1, wherein determining whether the estimated PSNR exceeds the predetermined reference value comprises determining a ratio between the PSNR calculated in previous frame in real time and the estimated PSNR.

3. The method as claimed in claim 1, wherein determining whether the estimated PSNR exceeds the predetermined reference value comprises determining a ratio between average of the PSNR calculated in previous frame in real time and the estimated PSNR.

4. The method as claimed in claim 2, wherein the calculated PSNR is generated by average square error of samples of the previous frames, which are reconstructed with the same corresponding relation to original samples of the previous frame, and the estimated PSNR are created by the average square error of samples of the previous frames, which is reconstructed with the same corresponding relation to original samples of the current frame.

5. The method as claimed in claim 1, wherein the error information is a mean square error (MSE) or a Sum of Absolute Difference (SAD).

6. The method as claimed in claim 3, wherein RatioPSNR, which is a ratio between the average of the calculated PSNR in the previous frames in real time, is calculated by
$${RatioPSNR}_{ i} = \frac{{PPSNR}_{ i}}{( \frac{1}{i - 1} ) {\sum }_{j = 1}^{i - 1} {CPSNR}_{j}} ,$$
wherein the PPSNR is a PSNR estimated in the current frame, CPSNR is the PSNR calculated in the previous frames, i is a frame number of the current frame, and j is a frame number of the immediately previous frame.

7. The method as claimed in claim 6, wherein the PPSNR and the CPSNR are calculated by
$$\begin{matrix}{PPSNR}_{ i} = 10 {log}_{10} \frac{{( {2}^{n} - 1 )}^{2}}{{PMSE}_{ i}} \\ and \\ {CPSNR}_{j} = 10 {log}_{10} \frac{{( {2}_{n} - 1 )}^{2}}{{CMSE}_{j}} ,\end{matrix}$$
wherein PMSE is a Mean Square Error (MSE) estimated in the current frame and CMSE is a MSE calculated in the previous frame, n indicates the number of the bit, and
the PMSE and the CMSE are calculated by
$$\begin{matrix}{PMSE}_{ i} = \frac{1}{MN} {\sum }_{m = 0}^{M - 1} {\sum }_{n = 0}^{N - 1} {( {O}_{mn}^{ i} - {R}_{n m}^{ i - 1} )}^{2} \\ and \\ {CMSE}_{j} = \frac{1}{MN} {\sum }_{m = 0}^{M - 1} {\sum }_{n = 0}^{N - 1} {( {O}_{mn}^{j} - {R}_{n m}^{j} )}^{2} ,\end{matrix}$$
wherein Oimn indicates an original sample in the m-th column and m-th row of i-th frame, and Rjmn indicates an reconstructed reference sample in the m-th column and n-th row of a j-th frame (a frame includes M[m]×N[n] pixels).

8. The method as claimed in claim 1, upon determining that the scene conversion occurred in the current frame, selectively controlling quantization parameters to address a scene conversion of the current frame.

9. The method as claimed in claim 2, wherein the error information is a mean square error (MSE) or a Sum of Absolute Difference (SAD).

10. The method as claimed in claim 3, wherein the error information is a mean square error (MSE) or a Sum of Absolute Difference (SAD).

11. A system for detecting a scene conversion in real time, comprising:
an encoder for estimating a Peak Signal to Noise Ratio (PSNR) of a current frame by using error information between the current frame and a previous frame, determining whether the estimated PSNR exceeds a predetermined reference value to detect a scene conversion, and controlling a video encoding data rate of the encoder when the estimated PSNR exceeds the predetermined reference value.

12. A system as claimed in claim 11, wherein determining whether the estimated PSNR exceeds the predetermined reference value comprises determining a ratio between the PSNR calculated in previous frame in real time and the estimated PSNR.

13. The system as claimed in claim 11, wherein determining whether the estimated PSNR exceeds the predetermined reference value comprises determining a ratio between average of the PSNR calculated in previous frame in real time and the estimated PSNR.

14. The system as claimed in claim 11, wherein the calculated PSNR is generated by average square error of samples of the previous frames, which are reconstructed with the same corresponding relation to original samples of the previous frame, and the estimated PSNR are created by the average square error of samples of the previous frames, which is reconstructed with the same corresponding relation to original samples of the current frame.

15. The system as claimed in claim 11, wherein the error information is a mean square error (MSE) or a Sum of Absolute Difference (SAD).

16. The system as claimed in claim 13, wherein a ratio between the average of the calculated PSNR in the previous frames in real time, is calculated by
$${RatioPSNR}_{ i} = \frac{{PPSNR}_{ i}}{( \frac{1}{i - 1} ) {\sum }_{j = 1}^{i - 1} {CPSNR}_{j}} ,$$
wherein the PPSNR is a PSNR estimated in the current frame, CPSNR is the PSNR calculated in the previous frames, i is a frame number of the current frame, and j is a frame number of the immediately previous frame.

17. The system as claimed in claim 16, wherein the PPSNR and the CPSNR are calculated by
$$\begin{matrix}{PPSNR}_{ i} = 10 {log}_{10} \frac{{( {2}^{n} - 1 )}^{2}}{{PMSE}_{ i}} \\ and \\ {CPSNR}_{j} = 10 {log}_{10} \frac{{( {2}_{n} - 1 )}^{2}}{{CMSE}_{j}} ,\end{matrix}$$
wherein PMSE is a Mean Square Error (MSE) estimated in the current frame and CMSE is a MSE calculated in the previous frame, n indicates the number of the bit, and
the PMSE and the CMSE are calculated by
$$\begin{matrix}{PMSE}_{ i} = \frac{1}{MN} {\sum }_{m = 0}^{M - 1} {\sum }_{n = 0}^{N - 1} {( {O}_{mn}^{ i} - {R}_{n m}^{ i - 1} )}^{2} \\ and \\ {CMSE}_{j} = \frac{1}{MN} {\sum }_{m = 0}^{M - 1} {\sum }_{n = 0}^{N - 1} {( {O}_{mn}^{j} - {R}_{n m}^{j} )}^{2} ,\end{matrix}$$
wherein Oimn indicates an original sample in the m-th column and m-th row of i-th frame, and Rjmn indicates an reconstructed reference sample in the m-th column and n-th row of a j-th frame (a frame includes M[m]×N[n] pixels).
